(19) United States
(12) Patent Application Publication
(10) Pub. No.: US 2023/0084776 A1
(43) Pub. Date: Mar. 16, 2023

(54) MULTI-PAYOR SINGLE-PRODUCT ARCHITECTURE AND METHODS

(71) Applicant: Resource Intl Inc. d/b/a Mishimoto, New Castle, DE (US)

(72) Inventor: Kristin Ann Valis, West Chester, PA (US)

(73) Assignee: Resource Intl Inc. d/b/a Mishimoto, New Castle, DE (US)

(21) Appl. No.: 17/942,030

(22) Filed: Sep. 9, 2022

Related U.S. Application Data
(60) Provisional application No. 63/242,581, filed on Sep. 10, 2021.

(51) Int. Cl. G06Q 20/12; G06Q 20/10; G06Q 10/08

(52) U.S. Cl. CPC G06Q 20/12; G06Q 20/102; G06Q 10/083

(57) ABSTRACT

Systems and methods are disclosed for a multi-payor single-product architecture. For example, providing a user interface to allow registration for a product having a product price, receiving a registration from a first user comprising a product selection and payment information for the product price, wherein the first user's payment information is stored without being charged, generating a link for the registered product, receiving payment information from a second user following the link, wherein the second payment information is charged, determining that one of: the product price has been met, or a predetermined time period has elapsed, whereupon a remaining amount of the product price is charged using the first user's payment information, and shipping the registered product to the first user.

### CROSS-REFERENCE TO RELATED APPLICATIONS

This application claims the benefit of U.S. Provisional Patent Application No. 63/242,581, filed Sep. 10, 2021, the contents of which are incorporated by reference herein in their entirety.

### BACKGROUND

Gift giving can be challenging for friends and family, both financially and in terms of selecting items that will be appreciated. Similarly, engagement with social media followers can seem superficial, particularly from the follower's perspective. It would be advantageous to develop an architecture (such as an online architecture) that allows multiple friends, family, or followers to contribute toward a meaningful item for which a designated recipient will be grateful.

### SUMMARY

Systems and methods are disclosed for a multi-payor single-product architecture. For example, the present invention includes providing a user interface to allow registration for a product having a product price, receiving a registration from a first user comprising a product selection and payment information for the product price, wherein the first user's payment information is stored without being charged, generating a link for the registered product, receiving payment information from a second user following the link, wherein the second payment information is charged, determining that one of: the product price has been met, or a predetermined time period has elapsed, whereupon a remaining amount of the product price is charged using the first user's payment information, and shipping the registered product to the first user.

### BRIEF DESCRIPTION OF THE DRAWINGS

FIG. 1 depicts a flow chart of a multi-payor single-product method according to the present disclosure.

FIG. 2 depicts a flow chart of another method of multi-payor single-product architecture.

FIG. 3 depicts a system architecture of multi-payor single-product architecture.

FIG. 4 depicts a flow chart of another method of multi-payor single-product architecture.

FIG. 5 is a schematic diagram of user interfaces.

### DETAILED DESCRIPTION

A multi-payor single-product architecture may allow a first user (e.g., customer) to share (e.g., via a link) a product to be purchased with a second user or users, such as potential supporters (e.g., family, friends, followers, etc.) who may contribute money to be used by the first user to purchase the product. For example, the first user may be a person interested in aftermarket automotive modifications. By way of example, internal combustion engine performance (e.g., in a vehicle) can be improved by aftermarket products, such as air (e.g., cold air) intake assemblies, which, for example, supply relatively greater volumes of air to the engine, as compared to a factory air intake system. Benefits of air intake assemblies, for example, include greater horsepower, improved acceleration, reduced pressure drop, obtention of more desirable air-to-fuel ratios, augmented engine sounds, and better filtration. Other aftermarket parts or accessories are contemplated as well.

The first user may be an automotive enthusiast and/or hobbyist, and the second user may be a friend or family member. The product may be a birthday or holiday gift. The product may be an item conventionally too expensive for one person to buy.

In another example, the first user may be an automotive influencer, such as a driver. By using the multi-payer architecture, followers (e.g., fans) of the racecar driver may be able to contribute to the purchase of a product (e.g., aftermarket automotive). Beneficially, a second user (e.g., follower) who contributes to a part may feel more engaged in the driver's success and may feel invested in the driver's progress. As will be discussed, the second user may receive recognition via the multi-payor single-product architecture.

The person setting up the account need not be the designated recipient of the product. For example, the first user may be an organizer, such as a manager, who merely acts to set up the account, inputting a desired product, a designated recipient, and other information. On the other hand, there is no prohibition on a first user appointing themself the designated recipient.

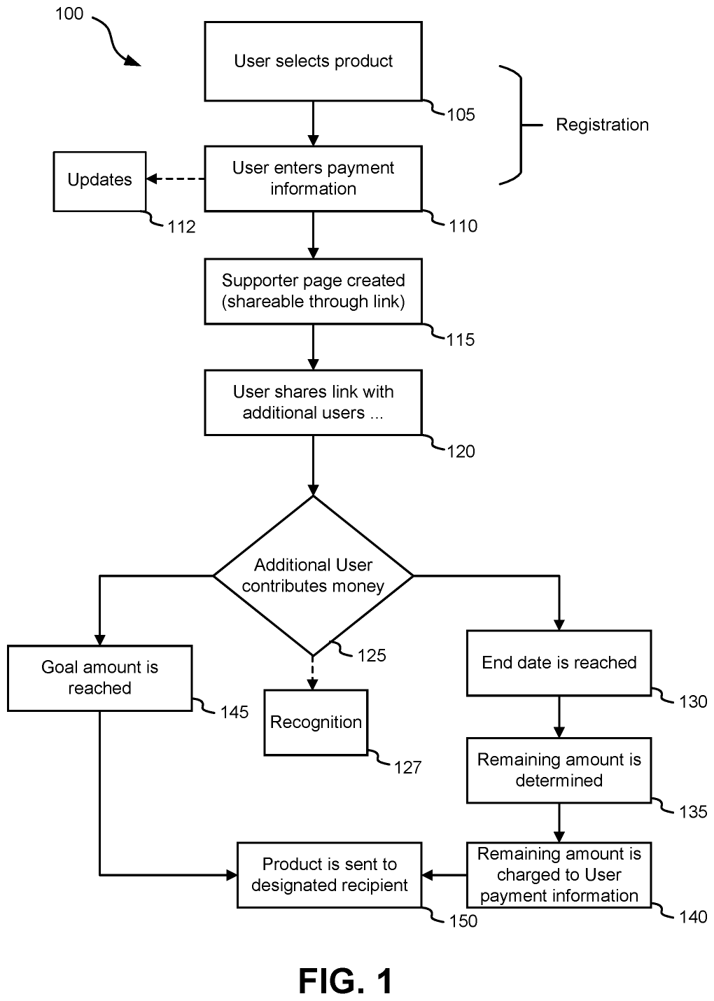

FIG. 1 depicts a flow chart 100 of a method of multi-payor single-product architecture. At 105, a user (e.g., a first user) may navigate to a vendor website configured with the multi-payor single-product architecture, determine to register, select a product, optionally set a goal amount, and/or set an end date. In some embodiments, the product may be an automotive product (e.g., an aftermarket automotive part) such as an air intake, a radiator, an intercooler, an oil cooler, etc.

In some examples, the goal amount may be the retail price of the product to be purchased by the first user. In another example, the goal amount may be a portion of the retail price of the product, such as a discounted price auto-filled by the vendor pursuant to a determination to encourage use of the multi-payor single-product architecture.

The first user may be prompted to set an end date. The end date may be a date when the purchase is effected, such as, for example, a birthday or deadline. Contributions for the product may stop being accepted on the end date. While a “no end date” option is possible, it is undesirable, as product availability varies with time, designated recipients typically want their product as soon as possible, and it would allow contributions for the product to be stuck in perpetuity. In some embodiments, the multi-payor single-product architecture may be configured to auto-fill the end date if not selected by the first user. The auto-filled end date may be set by the vendor, and may vary according to product popularity (e.g., shorter end dates for products which sell more quickly).

At 110, the first user may input payment information. Payment information may comprise debit card information, credit card information, Venmo, PayPal, etc. The payment information may be checked for adequate funds. The adequate funds may be equal to the price of the product to be purchased. A shipping address (for the designated recipient) and/or contact information may be added.

At 112, optionally, the first user may be prompted to select an updates setting. The first user may select automatic updates via social/email, for example, creation of the campaign, funds received toward goal (such as a percentage toward target), time until end date, etc. Alternatively, the first user can select manual control of updates, such as approving before sending, or completely manual. In some embodiments, the multi-payor single-product architecture may be configured to prepare updates at specific milestones or dates. In an example, the multi-payor single-product architecture may be configured to (e.g., based on a predetermined status) generate an update/graphic that the first user can share, such as if the remaining amount is 50%, etc.

At 115, a new registered product webpage (e.g., for supporters) may be created, for example, if the first user enters the payment information or registration is otherwise complete. The webpage may be a cloaked webpage that resembles the webpage where the first user registered to purchase the product. The webpage may have simplified content to aid ease of use for supporters (such as reduced content, no reviews, no links to other pages, etc.) For example, the first user may have registered to purchase the product on a company's (e.g., vendor's) website. If the first user enters the payment information, the webpage may be created that resembles the company's website. The webpage may include the company's name and/or other company details (e.g., company's mission statement). The webpage may include a description of the product to be purchased by the first user. In some examples, the first user may be able to add text on the webpage explaining why the first user is purchasing the product. For example, as the webpage is being created, the first user may be prompted by an intermediary interface to enter additional information relevant to the purchase. After the first user finalizes the additional information, the webpage may populate the additional information on the webpage. The webpage may include the goal amount and/or the end date, and/or trackers or other graphics to convey nearness to the goal amount.

At 120, the first user may be given a link to share. The first user may share the link via social network services (SNS) such as email, instant messaging, and/or cellular text messaging. The first user may post the link to one or more of the social media platforms (e.g., Facebook, Instagram, Twitter, etc.). The link may include a uniform resource locator (URL) which may direct a second user to the registered product webpage, for example, if the second user clicks the link. In some examples, the link may include an image. For example, the image may depict the product that the first user registered to purchased. For example, the first user might include a message while sharing the link, such as “Two weeks until my birthday and this intercooler would be FIRE!” or “Three weeks until my Drift event! Help!” The sharing of the link may be manual or automatic (as discussed above with reference to 112).

At 125, a second user (e.g., additional user, supporter) may follow the link to contribute money for the product. For example, the second user may click the link shared by the first user. It is understood that any number of users after the first user are contemplated (e.g., user N, N+1, N+2). For example, FIGS. 1, 2, and 4 refer to the second user as an additional user. The term “second user” is just to aid explanation and is not limited to a single user, but rather refers to all subsequent users after the first user.

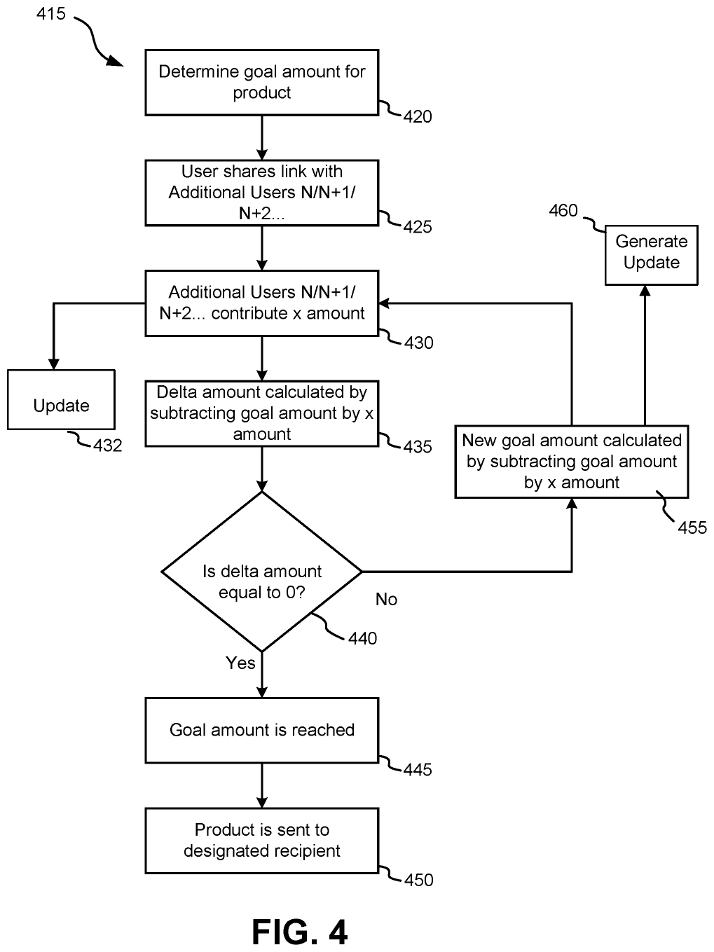

The second user may be directed to the registered product webpage (e.g., for supporters) where the product is listed along with the product description and the first users reasons for purchasing the product for the designated recipient, as described herein. A contribute option may be presented on the webpage, such as a button. The second user may click the contribute option and may be presented with a contribution interface asking the second user how much the second user wants to contribute and the second users payment information. The amount the second user enters to contribute may be subtracted from the goal amount and a remaining amount may be calculated, as described with respect to FIG. 4. In some examples, the remaining amount may be populated on the webpage. Second users may be able to set the contribution as public (e.g., showing the contributor's name and/or amount contributed) or private.

At 127, optionally, the multi-payor single-product architecture may be configured to recognize the second user's contribution. In some embodiments, the second user may be awarded loyalty points from the vendor where the product is being purchased. For example, the multi-payor single-product architecture may be configured to award the second user 1:1 dollars spent to points received loyalty program. This may encourage the customer to shop with the vendor again in the future.

Recognition need not be monetary or discount related. For example, the multi-payor single-product architecture may be configured to generate an update/graphic that the second user can share. People enjoy posting that they contributed to something. The multi-payor single-product architecture may be configured to track contributions and determine that a second user may have contributed to multiple gifts from different first users. Once determined, the multi-payor single-product architecture may be configured to designate the second user as a “super contributor.” The multi-payor single-product architecture may be configured to generate an update/graphic that the second user is a super contributor, for example, a badge the second user could then share on social media. Additionally, a super contributor may (e.g., may also) receive extra perks or increased loyalty points from the vendor. By way of example, if a second user contributes a predetermined amount of dollars (e.g., over a predetermined time period), and/or they contribute to a predetermined number of products (e.g., gifts) the multi-payor single-product architecture may be configured to determine the same and confer super contributor status.

At 130, an end date may be reached. The end date may be set by the first user or may be a default. The goal amount may not be satisfied when the end date is reached. For example, the total amount of money contributed by second users (e.g., supporters) may not be equal to the goal amount at the time of the end date.

At 135, a remaining amount may be generated, for example, if the goal amount is not satisfied at the time of the end date. The remaining amount may be generated (e.g., calculated) by subtracting the goal amount by the total amount contributed. In some examples, generating the remaining amount may occur at the time of the end date. In some examples, generating the remaining amount may occur at a time before the end date and may be stored in memory. In such a case, when the end date is reached, the remaining amount may be fetched from memory.

At 140, the remaining amount may be charged to the first user using the payment information. The first user may be notified that the end date has been reached and that the remaining amount is scheduled to be charged to the payment information. The first user may be notified via SNS messaging. Second users who contributed to the product may be notified via SNS messaging that the product is being purchased.

At 145, the goal amount may be satisfied. In some examples, the goal amount may be satisfied if the total amount contributed is equal to the goal amount, which may be assessed each time a new contribution is made. The first user may receive updates each time a new contribution is made and may be able to customize an automated reply email (e.g., a thank you email) to be sent to the second user. Whether the total amount contributed is equal to the goal amount may be assessed by subtracting the goal amount by the total amount contributed and checking to see if the goal amount is equal to zero, as described with respect to FIG. 4. The payment information may not be charged to the first user, for example, if the goal amount is equal to the retail price of the product.

If the goal amount is set at a price less than the retail price of the product, such that the first user planned to be sure of contributing to the gift, a remaining amount may be generated by subtracting the retail price by the goal amount. Upon the goal amount being satisfied, the remaining amount may be charged to the payment information.

In an alternative embodiment, in some examples, such as if the product is no longer in stock or if the remaining amount is a considerable portion of the product price (e.g., >30%, >40%, >50%, >60%, etc.), the architecture may allow the total amount contributed to be converted to a gift card for the designated recipient for other product(s) on the vendor's website.

In some examples, through lags in calculation (FIG. 4), contemporaneous contributions, etc., the contributions may exceed the goal amount, resulting in overage money. The overage money may be assigned to a gift card to be used (e.g., immediately used) by the designated recipient on other product(s) on the vendor's website.

At 150, the product may be sent to the designated recipient. The first user may be notified about the product being sent (e.g., via SNS messaging) and may be given tracking information and a delivery date. Second users who contributed to the product may be notified about the product being sent to the designated recipient.

Although the above example is directed to web-based vendors, other platforms are contemplated, guided by the foregoing description.

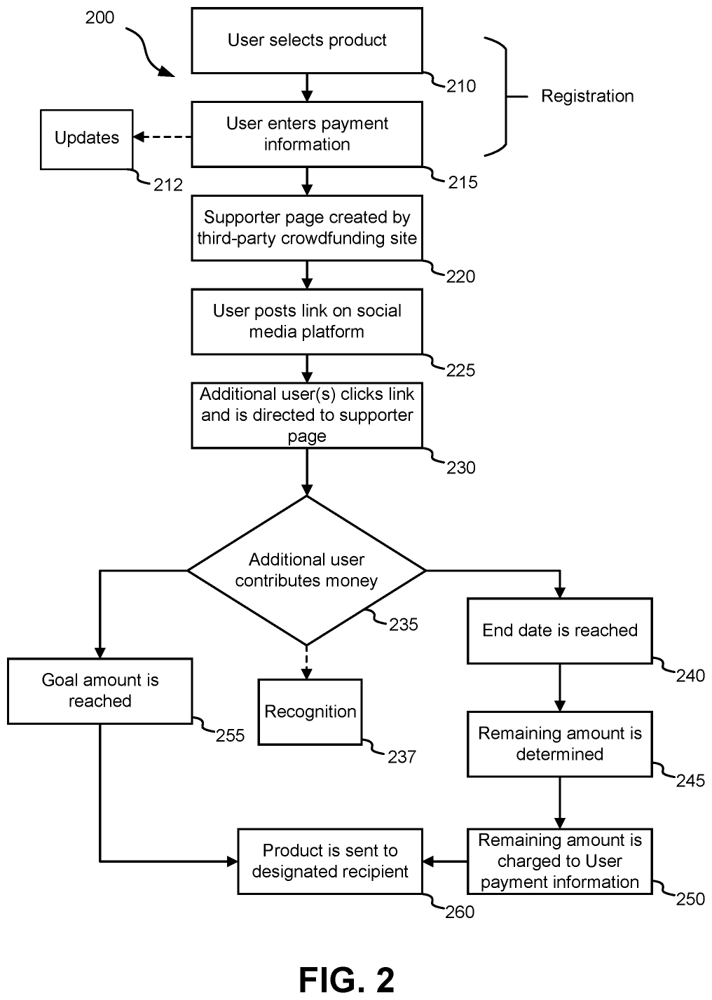

FIG. 2 depicts a flow chart 200 of another method of multi-payor single-product architecture. The multi-payor single-product architecture may include a third-party crowdfunding site (e.g., Kickstarter, GoFundMe, etc.). It is understood that the foregoing examples may be charitable endeavors, but they serve to show that with the necessary changes being made, a crowdfunding site could be adapted to provide software and/or a user interface as described herein. For example, the third-party site may be adapted to be transparent to the first user and/or the second users. Support for the multi-payor single-product architecture could be an additional revenue stream for a third-party crowdfunder.

At 210, a first user may select a product, set a goal amount, and/or set an end date as described with respect to FIG. 1.

At 212, optionally, the first user may be prompted to select an updates setting as described with respect to FIG. 1.

At 215, the first user may enter payment information as described with respect to FIG. 1. In some examples, the third-party payment service may be used to process the payment information (e.g., PayPal).

At 220, a webpage may be created, for example, if the first user finalizes entering the payment information. The webpage may be created by a third-party crowdfunding website that specializes in creating multi-payor platforms, the platform requiring adaptation to apply to the present architecture. For example, an agreement may be made between the vendor's website and the third-party website in which the third-party website may agree to host a webpage for the vendor's website. In such a case, the host servers may send information such as the details related to the product to be purchased, the goal amount, and the end date in a file (e.g., a JSON file) to the third-party servers. The third-party servers may use the received information when creating the third-party webpage. A link to the third-party webpage may be created and sent to the first user as described with respect to FIG. 1.

At 225, the first user may post the link to one or more of the social media platforms (e.g., Facebook, Instagram, Twitter, etc.) as described with respect to FIG. 1. In some examples, the third-party website may ask for access to see social media friends and/or followers. In such case, the third-party website may send an invitation to the friends and/or followers to contribute to the product that the first user is attempting to purchase. The invitation may include a description of the product and the reasons why the first user is purchasing the product.

At 230, a second user may click the link and be directed to the third-party webpage. In some examples, the second user may be asked to make an account with the third-party webpage. In some examples, the second user may be able to continue as a guest on the third-party webpage.

At 235, a second user may contribute money as described with respect to FIG. 1. The third-party website may manage the contribution money using traditional processes. In some examples, the third-party website may send information (e.g., using an application programming interface (API)) related to the transaction to the local host who may manage the contribution money using its own processes. The third-party webpage may include text inputs where a user may enter payment information and a contribution amount.

At 237, optionally, the multi-payor single-product architecture may be configured to recognize the second user's contribution as described with respect to FIG. 1, for example, as determined in the initial agreement between the vendor's website and the third-party website.

At 240, an end date may be reached as described with respect to FIG. 1.

At 245, the remaining amount may be generated as described with respect to FIG. 1 and FIG. 4. In some examples, the third-party website may use a local process to generate the remaining amount, for example, if the third-party website is responsible for managing the contribution money.

At 250, the remaining amount may be charged to the payment information. The remaining amount may be generated remotely by the third-party website and sent via a message to the local host. In such a case, the local host may charge the remaining amount to the payment information, for example, after receiving the message from the third-party website. In some examples, the third-party website may be responsible for charging the payment information and may use its own payment process to charge the payment information. Allocating the responsibilities may be determined in the initial agreement between the vendor's website and the third-party website.

At 255, the goal amount may be reached as described with respect to FIG. 1. The third-party website may notify the vendor's website, for example, if the goal amount is reached.

At 260, the product may be sent to the designated recipient as described with respect to FIG. 1.

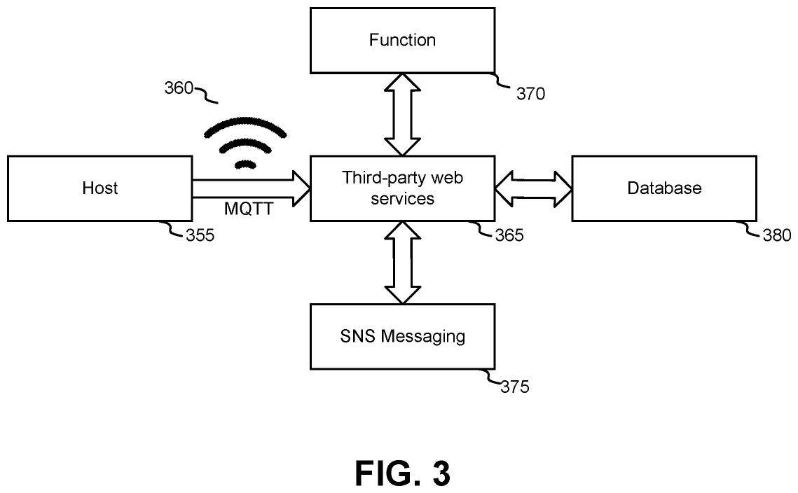

FIG. 3 depicts a system architecture of multi-payor single-product architecture. In some examples, the third-party services 365 may be Amazon's Internet of Things (loT). A local host computer 355 may allow a user to select a product and to designate the product for the system. The local host computer 355 and the third-party web services 365 may enter into an agreement. The agreement may include details on data security. The agreement may allow the local host computer 355 to customize each of the third-party web services, resulting in a third-party web service customized state.

The third-party web services 365 may send a key to the local host computer 355, for example, if the agreement is finalized. The key may allow the local host computer 355 access to the third-party web services 365. If the local host computer 355 customized any of third-party web services 365, the key may allow the third-party web services 365 to reset the third-party web service to its customized state upon the local host computer 355 gaining access to the third-party web service.

One of the third-party web services 365 may be a database 380 (e.g., Amazon's DynamoDB). A user may finalize purchasing the product, setting the goal amount, and/or setting the end date as described with respect to FIGS. 1 and 2. Information related the product, the goal amount, and/or the end date may be published (e.g., via message queuing telemetry transport 360 (MQTT) to the database 380 and stored in the database 380. A user of the local host computer 355 may be able to access the third-party web services 365 with the key, navigate to the database 380, and see the information.

A user may contribute to the product as described with respect to FIGS. 1 and 2. The local host computer 355 may publish information related to the contribution to the database 380, including which product the contribution is associated with. In this way, the database 380 may be able to store multiple user's projects.

Each time a new contribution is submitted, a new input may be added to the database 380 that includes information related to the new contribution. At this time, a function 370 web service (e.g., Amazon's Lambda function) may be called. The function 370 may receive as inputs information from the database 380 and may run a program that checks if the goal amount has been reached, as described with respect to FIG. 4. If the goal amount is reached, SNS messaging 375 may be used to notify the local host computer 355 that the goal amount is reached. In such a case, the local host computer 355 may proceed with shipping the product to the designated recipient as described with respect to FIGS. 1 and 2.

FIG. 4 depicts a flow chart 415 of a method of checking whether goal amount is reached. At 420, the goal amount is determined as described with respect to FIGS. 1 and 2.

At 425, the first user may share links with one or more second users (e.g., user N, user N+1, user N+2, etc.) as described with respect to FIGS. 1 and 2. In some examples, information associated with each user may be stored in the database described with respect to FIG. 3.

At 430, a second user (e.g., user N) may contribute a certain amount of money. For example, user N may contribute x amount. The method may include reading the x amount and setting a parameter and/or variable in a function with the x amount. The function may be responsible for checking whether the goal amount has been reached (e.g., satisfied).

At 432, the contribution may be used to update stored information about the second user(s), for example, so the multi-payor single-product architecture may recognize the second user's contribution (as described at step 127 of FIG. 1). This can be repeated for subsequent second users (N+1, N+2, . . . ).

At 435, a delta amount may be generated (e.g., calculated). In some examples, the delta amount may be the same as the remaining amount as described with respect to FIGS. 1 and 2. The delta amount may be calculated by subtracting the goal amount by the x amount. In some examples, the delta amount may be calculated by subtracting the goal amount by a percentage of the x amount.

At 440, it may be determined whether the delta amount equals zero. In some examples, it may be determined whether the delta amount crosses a threshold. For example, it may be determined whether the delta amount crosses the numerical value of five if the threshold is set to five.

At 445, the goal amount may be reached if it is determined that the delta amount is equal to zero (“Yes”). In some examples, the goal amount may be reached if the delta amount crosses a threshold.

At 450, the product may be sent to the designated recipient as described with respect to FIGS. 1 and 2.

At 455, it may be determined that the delta amount is not equal to zero (“No”) and that the goal amount has not been reached. The goal amount may be adjusted by subtracting it by the x amount.

At 460, the multi-payor single-product architecture may be configured to generate an update/graphic to post the new goal amount.

After the adjustment, a subsequent second users (user N+1) contribution may be read and set as the new x amount. The loop may continue, for example, until the delta amount equals zero, which signals the goal amount has been reached.

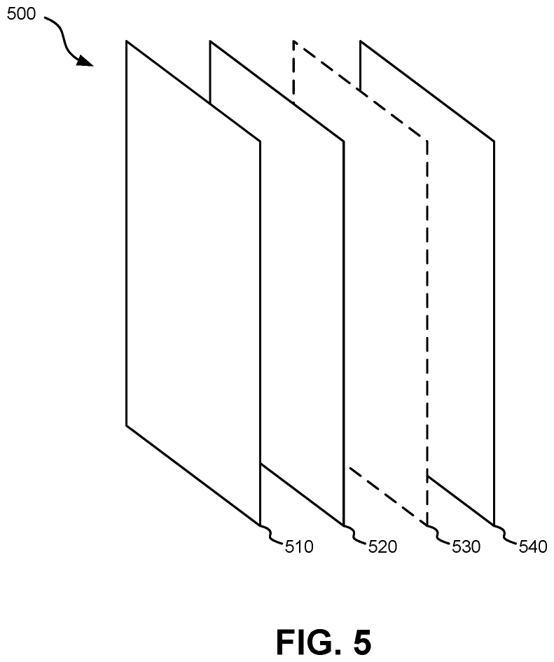

FIG. 5 is a schematic diagram of a plurality of user interfaces 500 for a website employing a multi-payor single-product architecture. A general landing page 510 (and associated links) may be provided. Upon selection, a registration setup page 520 may be generated as described above. An optional status page 530 may be generated to allow the first user and/or the second users to track the progress of the campaign. A supporter webpage 540 (e.g., registered product webpage (e.g., for supporters)) may be provided to allow supporters following the link (SNS or social) to contribute.

1. (canceled)

2. A multi-payor single-product architecture, comprising:
a memory; and
a processor configured to:
receive a registration from a first user comprising a product selection and payment information for the product price, wherein the first user's payment information is stored without being charged;
generate a link for the registered product;
receive payment information from a second user following the link, wherein the second payment information is charged; and
determine that one of:
the product price has been met; or
a predetermined time period has elapsed, whereupon a remaining amount of the product price is charged using the first user's payment information.

3. The multi-payor single-product architecture of claim 2, wherein the processor is further configured to apply a discount to the product price.

4. The multi-payor single-product architecture of claim 2, wherein the processor is further configured to prompt the first user to set a goal amount, and thereafter, to compare the goal amount to the product price.

5. The multi-payor single-product architecture of claim 2, wherein the processor is further configured to prompt the first user to enter an end date which will be used to calculate the predetermined time period.

6. The multi-payor single-product architecture of claim 2, wherein the processor is further configured to prompt the first user to enter information about why the product was selected.

7. The multi-payor single-product architecture of claim 2, wherein the processor is further configured to prompt the first user to select an updates setting.

8. The multi-payor single-product architecture of claim 2, wherein the processor is further configured to prepare an update for dissemination via social media by the first user.

9. The multi-payor single-product architecture of claim 8, wherein the update is one or more of creation of the campaign, percentage towards target, and time remaining until the predetermined time period elapses.

10. The multi-payor single-product architecture of claim 8, wherein the update includes the link.

11. The multi-payor single-product architecture of claim 2, wherein the processor is further configured to display to the second user a registered product webpage having a contribute option.

12. The multi-payor single-product architecture of claim 2, wherein the processor is further configured to store information about the second user.

13. The multi-payor single-product architecture of claim 2, wherein the processor is further configured to determine a monetary amount between the product price and the charged second payment.

14. The multi-payor single-product architecture of claim 2, wherein the processor is further configured to recognize the second user's contribution by one or more of awarding the second user loyalty points and generating an update for dissemination via social media by the second user.

15. The multi-payor single-product architecture of claim 2, wherein the processor is further configured to determine the second user has accessed the multi-payor single-product architecture previously, has satisfied a predetermined threshold for a monetary amount or a number of instances, and recognize the second user's contribution with one or more of loyalty points or by generating an update for dissemination via social media by the second user.

16. The multi-payor single-product architecture of claim 15, wherein the update is a social media badge for the second user.

17. A method, comprising:
providing a user interface to allow registration for a product having a product price;
receiving a registration from a first user comprising a product selection and payment information for the product price, wherein the first user's payment information is stored without being charged;
generating a link for the registered product;
receiving payment information from a second user following the link, wherein the second payment information is charged;
determining that one of:
the product price has been met; or
a predetermined time period has elapsed, whereupon a remaining amount of the product price is charged using the first user's payment information; and
shipping the registered product to a designated recipient.

18. The method of claim 17, further comprising preparing a first update for dissemination via social media by the first user.

19. The method of claim 18, further comprising preparing a second update for dissemination via social media by the first user.

20. The method of claim 17, further comprising preparing an update for dissemination via social media by the second user.

21. The method of claim 17, wherein, if the product price is exceeded, sending a gift card to the designated recipient.
